(19) United States
(12) Patent Application Publication
(10) Pub. No.: US 2012/0217104 A1
(43) Pub. Date: Aug. 30, 2012

(54) PLAY ADJUSTMENT IN A HYDRAULIC BRAKING SYSTEM

(75) Inventors: Matthias Liermann, Essen (DE); Christian Stammen, Kaarst (DE)

(73) Assignee: SIEMENS AKTIENGESELLSCHAFT, MUENCHEN (DE)

(21) Appl. No.: 13/498,981

(22) PCT Filed: Aug. 24, 2010
(86) PCT No.: PCT/EP2010/062290

§ 371 Date: May 18, 2012

(30) Foreign Application Priority Data
Sep. 29, 2009 (DE) 10 2009 048 667.4

(51) Int. Cl. B61H 5/00; B60T 13/22; F16D 65/72; B61H 15/00; F16D 55/02; F16D 65/16

(52) U.S. Cl. 188/71.8

(57) ABSTRACT

An economical, light and reliable hydraulic braking system for braking a moving mass includes a pressure element or press part for pressing onto a brake surface under frictional contact, a brake actuator filled with hydraulic fluid for producing pressure in the pressure element and a spacing device for adjusting play between the pressure element and the brake surface when the brake system is in a released or non-active position. The spacing device includes a hydraulic accumulator for accumulating a predefined volume of hydraulic fluid at a minimum pressure. The hydraulic accumulator can be connected to the brake actuator, thus avoiding the use of mechanical stopping or blocking devices.

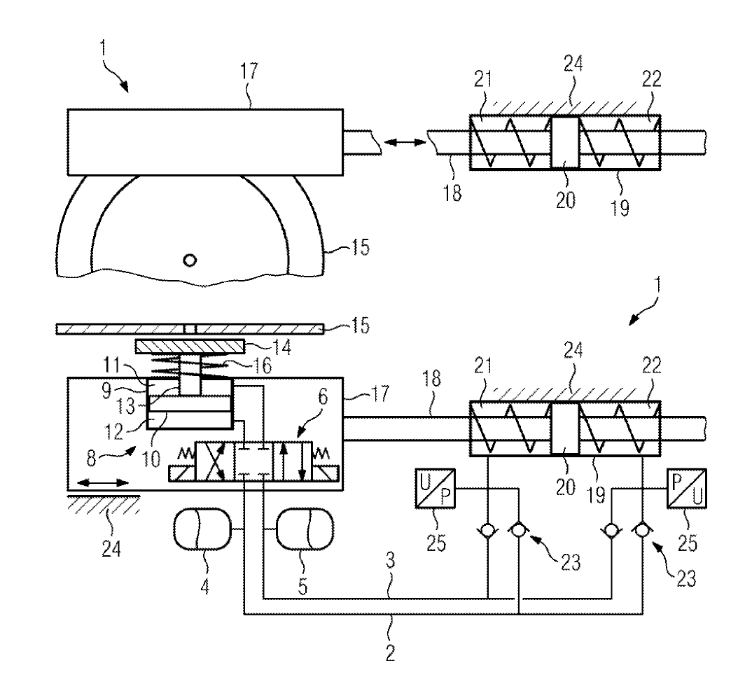

The invention relates to a hydraulic braking system for slowing down a moving mass, comprising a press part for pressing against a brake surface with frictional contact, a brake actuator filled with hydraulic fluid for generating a pressure which can be introduced into the press part, and spacer means for adjusting play between the press part and the brake surface when the braking system is in a released position.

The invention also relates to a method for adjusting play in a hydraulic brake.

Such a hydraulic braking system and such a method are already known from the general prior art. To release a friction brake, the brake linings or other friction elements, which are referred to commonly herein by the term “press part”, have to be lifted from the brake surface. The return stroke of an actuation device used for the lifting operation has to be limited by a stop so that the brake lining is not removed too far from the brake surface when the brake is released. There are different mechanical solutions for limiting the stroke depending on whether the braking system is designed actively or passively.

The object of the invention is to provide an economical, light and reliable hydraulic braking system of the type described in the introduction.

The invention achieves this object based on the braking system described in the introduction, since the spacer means have a hydraulic accumulator for accumulating a predefined volume of hydraulic fluid at a minimum pressure, wherein the hydraulic accumulator is connectable to the brake actuator so that mechanical stopping or blocking means are avoided.

Based on the method described in the introduction, the invention achieves the object since a predefined volume of a hydraulic fluid, to which a predefined pressure is applied, is used to move the press part so as to lift the press part from the brake surface, wherein merely the volume of hydraulic fluid used for this purpose limits the movement of the press part and thus determines the distance between the press part and the brake surface in a released position of the brake.

In accordance with the invention, the play between the press part and a brake surface, in other words the distance between the press part and brake surface, is not adjusted with the aid of mechanical stops or blocking means for example. In accordance with the invention, a limited volume of hydraulic fluid is used, which causes a likewise defined movement of the press part. The press part is a brake lining, a brake pad, or another friction element for example, wherein the brake surface is formed on a brake disc for example which is rotationally engaged with an axle of a rail vehicle. Deviating from this, however, it is also possible that the brake surface is the surface of a rail, a wheel or the like. The braking system may, in principle, be an active or passive braking system. In active hydraulic braking systems, the press part is pressed onto the brake surface with frictional contact as a result of a built-up hydraulic pressure so that a braking deceleration is adjusted between the friction partners due to the friction effect. Within the scope of the invention, a predefined volume of a hydraulic fluid at a prescribed pressure or pressure range is used to release this frictional contact. The volume of hydraulic fluid determines the return stroke of the press part from the brake surface, that is to say the distance between the two friction partners in a released position of the braking system. The volume necessary for release is accumulated before and/or during the braking process. The hydraulic accumulator is expediently used for this accumulation process. For example, the hydraulic accumulator is a hydraulic chamber of a hydraulic cylinder into which a hydraulic piston extends movably, wherein the hydraulic piston and the hydraulic cylinder together tightly delimit the hydraulic accumulator. The hydraulic piston impresses the desired predefined minimum pressure on the hydraulic fluid, the pressure being produced for example by the tension of a spring which is arranged outside the hydraulic chamber and which is supported on the hydraulic piston and on the hydraulic cylinder. A complex mechanical limitation is made superfluous by the adjustment according to the invention of play between the press part and the brake surface. This also means that the hydraulic braking system according to the invention is very light and economical. In addition, the hydraulic braking system according to the invention is relatively reliable and has greater availability since, in contrast to mechanical components, no signs of fatigue or other ageing processes can occur.

The brake actuator is expediently connectable to the hydraulic accumulator to lift the press part from the brake surface, wherein the volume of hydraulic fluid in the hydraulic accumulator determines the distance between the press part and the brake surface in the released position of the braking system.

In accordance with this advantageous development of the invention, the hydraulic accumulator cooperates with the brake actuator, wherein the cooperation thereof can be controlled or adjusted by suitable hydraulic switch means.

A compression spring for pressing the press part against the brake surface is advantageously provided. A passive braking system is provided in accordance with this advantageous development. The passive braking system has a spring, which presses the press part against the brake surface if there is a lack of hydraulic pressure in the brake actuator, and thus produces frictional contact. The moved mass is slowed down as a result of the frictional contact. A hydraulic pressure is necessary to release the press part from the brake surface. The hydraulic fluid necessary for the lifting operation is provided by the hydraulic accumulator.

The brake actuator expediently has a brake cylinder in which a brake piston extends which is guided so as to be movable in the longitudinal direction, wherein the brake piston and the brake cylinder delimit at least one brake chamber.

The brake cylinder is expediently a differential cylinder. In differential cylinders the piston rod connected rigidly to the brake piston is only formed on one side of the brake piston. Two effective areas of different size are thus provided, since merely the ring area is effective on the rod side, but the entire piston area is effective on the side of the piston remote from the rod. If the pressure is therefore equal on either side of the piston, the piston is displaced towards the rod sided. This is advantageous for safety reasons for example, since if a hydraulic system fails for example, the piston of the differential cylinder will always be displaced towards one side. This may be sufficient to provide a desired braking effect in an emergency.

The brake actuator is expediently connected by means of a control valve to a high-pressure line and/or to a low-pressure line, wherein the high-pressure line and the low-pressure line are each filled with a hydraulic fluid, and the pressure of the hydraulic fluid in the high-pressure line is greater than the pressure of the hydraulic fluid in the low-pressure line. The control valve determines the level of pressure which prevails on each side of the differential cylinder.

The hydraulic accumulator is expediently connected to the high-pressure line.

In accordance with a preferred embodiment of the invention, the press part is supported, by connection means, on a pressure generator which can be fixed to a frame of the mass to be slowed down, said pressure generator having a support cylinder filled with hydraulic fluid and a support piston cooperating therewith, wherein the support cylinder communicates with the brake actuator via hydraulic lines. A self-energizing hydraulic brake is provided in accordance with this advantageous development. Only a small starting force, which produces the frictional contact between the press part and the brake surface, is to be introduced initially into the press part. The press part is not supported by a suitable mechanism on a frame of the mass to be slowed down for example, but is supported on a hydraulic column which is located in a support cylinder. A support piston which is connected to the press part, for example by means of a suitable lever mechanism, projects into the support cylinder. The press part is part of a tensioning device, or in other words is part of a caliper, which is not normally fixed to a frame of the mass to be slowed down, as in the prior art. Rather, the brake part or the caliper is mounted so as to be movable. Due to the movement of the mass to be slowed down with frictional contact, a force is therefore introduced into the caliper and is introduced into the support piston by a suitable lever mechanism. This compresses the hydraulic column of the support cylinder so that the pressure in the brake actuator is reinforced due to the connection between the support cylinder and the brake cylinder.

The method according to the invention is expediently carried out in such a way that the defined volume of hydraulic fluid for releasing the brake is introduced into a hydraulic chamber of a brake actuator, wherein a movably guided brake piston is moved and delimits the hydraulic chamber.

Further exemplary embodiments and advantages of the invention are detailed in the following description of an exemplary embodiment of the hydraulic braking system according to the invention, given with reference to the accompanying

FIGURE, which schematically illustrates an exemplary embodiment of the braking system according to the invention.

The FIGURE shows a schematic illustration of an exemplary embodiment of the braking system 1 according to the invention, wherein the apparatus 1 is shown in a partly sectional plan view in the lower part of the FIGURE, and the braking system 1 is shown in a partly sectional side view in the upper part of the FIGURE. It can be seen that the hydraulic braking system 1 has a high-pressure circuit 2 and a low-pressure circuit 3, which are connected to a hydraulic accumulator 4 and to a low-pressure container 5 respectively. The high-pressure circuit 2 and the low-pressure circuit 3 are connected to a brake actuator 8 via an analogous control valve 6, which acts as a brake valve, said brake actuator having a brake cylinder 9 and a press part 14. The brake cylinder 9 is divided by a brake piston 10 into a brake chamber 12 and a brake return chamber 11. A coupling rod 13 extends from the brake piston 10 to the press part 14, which is provided to press against a brake disc 15. The brake disc 15 is rotationally engaged with the axle of the rail vehicle for example. A biased compression spring 16 is further provided between the brake cylinder 9 and the press part 14, and is supported on the press part and also on the brake cylinder 9. It can be seen that the brake cylinder 9 is formed as a differential cylinder. In other words, the coupling rod 13 is only arranged on one side of the brake piston 10, and therefore effective areas of different size are formed on the brake piston 10. The side of the brake piston 10 remote from the piston rod has a greater effective area since the pressure of the hydraulic fluid can only be applied to the ring area on the piston rod side. Frictional contact is thus produced between the press part 14 and the brake surface 15 if the pressure is equal on either side. The braking force introduced into the press part 14 is aided by the compression spring 16.

With its brake cylinder 9, the press part 14, the compression spring 16 and the coupling rod 13 together with the control valve 6, the brake actuator 8 is part of a tensioning device 17, which, as indicated by the double-headed arrow, is not mounted rigidly in a frame 24 of a rail vehicle, but is instead mounted movably. The tensioning device 17 is supported via connection means 18 on a support cylinder 19 which is filled with hydraulic fluid and which is connected rigidly to the frame 24 of the rail vehicle to be slowed down. To this end, the connection means 18 are connected to a support piston 20 projecting into the support cylinder 19. The support cylinder 19 is formed as a “synchronous cylinder”, and the effective areas of the support piston 20 are the same on either side. The support piston 20 divides the support cylinder 19 into a support chamber 21 and into an output chamber 22. The support chamber 21 and the output chamber 22 are connected via hydraulic lines to the low-pressure circuit 3 and to the high-pressure circuit 2 respectively. Measurement sensors 25 are provided to monitor the hydraulic pressure, the hydraulic pressure P being applied on the input side of said measurement sensors and a voltage U corresponding to the hydraulic pressure P being provided on the output side of said measurement sensors.

The hydraulic braking system according to the invention acts as follows: for example, pressure is balanced between the brake chamber 12 and the brake return chamber 11 in order to initiate a braking process. Due to the spring 16 and the effective areas of different size of the brake piston 10, the press part 14 is displaced against the brake surface 15 with frictional contact. The brake surface 15 rotates during travel of the rail vehicle so that a force is introduced into the press part 14 and therefore into the entire tensioning device 17 due to the frictional contact between the press part 14 and the brake surface 15. This force acts on the hydraulic column in the output 22. The pressure of the hydraulic fluid increases in the output chamber 22. If the pressure in the output chamber 22 is greater than the pressure in the high-pressure circuit 2, a return valve 23 opens, wherein the hydraulic pressure in the brake actuator 8, and therefore the force with which the press part is pressed against the brake surface, is increased. Since the rail vehicle can move in two directions, the same is true for the support chamber 21. At the same time, a determined additional volume of hydraulic fluid is accumulated in the hydraulic accumulator 4 during the braking process. The total volume of hydraulic fluid in the hydraulic accumulator determines the subsequent distance of the press part 14 from the brake surface 15.

To release the brake, the control valve 6 connects the high-pressure circuit 2 and therefore the hydraulic accumulator 4 to the brake return chamber 11 of the brake actuator 8. Due to the pressure in the hydraulic accumulator 4, the brake piston 10 is moved, thus increasing the volume of the brake return chamber 11, wherein the press part 14 is lifted from the brake surface 15, thus creating play. This lifting continues until the entire volume of hydraulic fluid of the hydraulic accumulator 4 has been consumed. In other words, the volume of hydraulic fluid accumulated in the hydraulic accumulator defines the return stroke of the press part 14 from the brake surface 15.

1-10. (canceled)

11. A hydraulic braking system for braking a moving mass, the hydraulic braking system comprising:
a pressure element for pressing against a brake surface with frictional contact;
a brake actuator filled with hydraulic fluid for generating a pressure to be introduced into said pressure element; and
a spacing device for adjusting play between said pressure element and said brake surface when the braking system is in a released position;
said spacing device having a hydraulic accumulator for accumulating a predefined volume of hydraulic fluid at a minimum pressure; and
said hydraulic accumulator configured to be connected to said brake actuator to avoid using mechanical stopping or blocking devices.

12. The hydraulic braking system according to claim 11, wherein:
said brake actuator is configured to be connected to said hydraulic accumulator to lift said pressure element from said brake surface; and
said hydraulic accumulator contains a volume of hydraulic fluid determining a distance of said pressure element from said brake surface in said released position of the braking system.

13. The hydraulic braking system according to claim 12, which further comprises a compression spring for pressing said pressure element against said brake surface.

14. The hydraulic braking system according to claim 11, wherein said brake actuator has a brake cylinder and a brake piston extended and guided in said brake cylinder so as to be movable in longitudinal direction, said brake piston and said brake cylinder delimiting at least one brake chamber.

15. The hydraulic braking system according to claim 14, wherein said brake cylinder is a differential cylinder.

16. The hydraulic braking system according to claim 14, which further comprises:
a high-pressure line and a low-pressure line;
a control valve connecting said brake actuator to at least one of said high-pressure line or said low-pressure line;
said high-pressure line and said low-pressure line each being filled with a hydraulic fluid; and
a pressure of the hydraulic fluid in said high-pressure line is greater than a pressure of the hydraulic fluid in said low-pressure line.

17. The hydraulic braking system according to claim 16, wherein said hydraulic accumulator is connected to said high-pressure line.

18. The hydraulic braking system according to claim 11, which further comprises:
a pressure generator configured to be fixed to a frame of the mass to be braked;
a connector supporting said pressure element on said pressure generator;
said pressure generator having a support cylinder filled with hydraulic fluid and a support piston cooperating with said support cylinder; and
hydraulic lines through which said support cylinder communicates with said brake actuator.

19. A method for adjusting play between a pressure element of a hydraulic brake and a brake surface, the method comprising the following steps:
applying a predefined pressure to a predefined volume of a hydraulic fluid, to move the pressure element and lift the pressure element from the brake surface; and
using only the volume of the hydraulic fluid to delimit the movement of the pressure element and determine a distance between the pressure element and the brake surface in a released position of the brake.

20. The method according to claim 19, which further comprises:
introducing the predefined volume of hydraulic fluid into a hydraulic chamber of a brake actuator for releasing the brake; and
moving a movably guided brake piston to delimit the hydraulic chamber.
